(19) United States
(12) Patent Application Publication
(10) Pub. No.: US 2015/0299015 A1
(43) Pub. Date: Oct. 22, 2015

(54) Method for controlling desalination and salt discharging in supercritical water oxidation system

(71) Applicant: XI'AN JIAOTONG UNIVERSITY, Xi"an, Shaanxi (CN)

(72) Inventors: Shuzhong Wang, Xi'an (CN); Lu Zhou, Xi'an (CN); Donghai Xu, Xi'an (CN); Xingying Tang, Xi'an (CN); Honghe Ma, Xi'an (CN)

(21) Appl. No.: 14/396,740

(22) PCT Filed: Dec. 5, 2012
(86) PCT No.: PCT/CN2012/085888

§ 371 Date: Dec. 30, 2014

(30) Foreign Application Priority Data
Apr. 23, 2012 (CN) 201210120218.1

(51) Int. Cl. C02F 9/00; B01D 21/26; C02F 1/06; B01D 3/06; C02F 1/00; C02F 1/72

(52) U.S. Cl. CPC C02F 9/00; C02F 1/00; C02F 1/72; C02F 1/06; B01D 3/06; B01D 21/267; C02F 2103/08

(57) ABSTRACT

A method for controlling desalination and salt discharging in a supercritical water oxidation system includes a step of providing a system including a heating furnace (1), a hydrocyclone (2), a buffer oxidizer (3), a flash tank (4) and related control valves. The method further includes a step of controlling desalination and salt discharging: discharging salts from the hydrocyclone (2) into the buffer oxidizer (3); discharging the salts from the buffer oxidizer (3) into the flash tank (4), in an intermittent automatic operation manner The method accomplishes an efficient and continuous desalination of the organic waste supercritical water oxidation treatment system, via storing the salts by the salt storage buffer tank under the hydrocyclone (2) and the buffer oxidizer (3).

### CROSS REFERENCE OF RELATED APPLICATION

This is a U.S. National Stage under 35 U.S.0 371 of the International Application PCT/CN2012/085888, filed Dec. 5, 2012, which claims priority under 35 U.S.C. 119(a-d) to CN 201210120218.1, filed Apr. 23, 2012.

### BACKGROUND OF THE PRESENT INVENTION

1. Field of Invention

The present invention relates to a supercritical water treatment of waste organics, and more particularly to a method for controlling desalination and salt discharging in a supercritical water treatment system for the waste organics.

2. Description of Related Arts

The Supercritical Water Oxidation (SCWO) technology is capable of processing various kinds of organic wastes with an in-depth oxidation treatment. In the supercritical water, the organics are able to mix with the non-polar gas, such as the air and oxygen, so as to form a homogenous reaction system and accomplish an efficient and rapid decomposition of the organics into small molecular products, such as H₂O, CO₂ and N₂. Although most salts have a high solubility, usually at a range of tens to 100 g/L, in water at a normal temperature and a normal pressure, the inorganic salts have an obviously lower solubility, usually (1-100)*10⁻⁶ (weight percentage), in the supercritical water. Therefore, the inorganic salts are usually liable to precipitate out.

For the related organic wastes SCWO treatment devices, the equipments and pipelines blockage caused by the precipitation comprising the inorganic salts is one of the biggest difficulties affecting the industrialization of the SCWO treatment technology. In the SCWO treatment industrial application systems, the establishment of a durable and stale desalination system is essential for maintaining a secure operation of the whole SCWO treatment system, and currently becomes the key problem urgently remaining to be solved in the development of the SCWO treatment system. The desalinations of the conventional SCWO organic waste treatment systems are divided into two types, a pre-reaction desalination and a post-reaction desalination, according to the timing of the desalination; a continuous desalination and an intermittent desalination, according to system procedures; or, a high-pressure direct desalination and a post-depressurized desalination, according to operation conditions. A continuous and stable desalination and an effective depressurizing and cooling manner are the targets remaining to be accomplished.

The high-temperature and high-pressure operative conditions pose a strict requirement to the operation and control of the organic waste SCWO desalination and salt discharging system. Despite of the conventional various organic waste SCWO systems with the desalination and salt discharging, no reports concerting a controlling method of the organic waste SCWO desalination and salt discharging system have been found.

### SUMMARY OF THE PRESENT INVENTION

In order to accomplish an organic waste SCWO treatment system having a stable operation of desalination and salt discharging, the present invention provides a method for controlling desalination and salt discharging in an organic waste SCWO treatment system.

Accordingly, in order to accomplish the above objects, the present invention adopts following technical solutions.

A method for controlling desalination and salt discharging in a SCWO system comprises steps of:

providing a SCWO system: connecting an introducing pipe of a heating furnace to an inlet of a hydrocyclone; connecting an overflow mouth at a top of the hydrocyclone to a pipe which leads back to the heating furnace; providing a salt storage buffer tank which is connected to a built-in transporting motor thereof at a bottom of the hydrocyclone ; connecting an outlet of the salt storage buffer tank to a buffer oxidizer which has a built-in transporting motor thereof via a first valve; connecting an inlet of the buffer oxidizer to an oxygen-feeding pipe via a sixth valve; providing a filter in the buffer oxidizer; connecting an outlet of the filter to the overflow mouth of the hydrocyclone via a second valve; connecting an outlet at a bottom of the buffer oxidizer to a flash tank via a third valve; connecting a first outlet at a top of the flash tank to a storage tank via a fourth valve; and connecting a second outlet at a bottom of the flash tank to a salt storage via a fifth valve; and

controlling desalination and salt discharging of the SCWO system, comprising steps of:

(1) initially, closing the first, the second, the third, the fourth, the fifth and the sixth valves, and stopping the transporting motor of the hydrocylcone and the transporting motor of the buffer oxidizer;

(2) starting the SCWO system, entering the inlet of the hydrocyclone by organic wastewater, slowly opening the sixth valve to a certain degree for introducing oxygen into the buffer oxidizer and increasing a pressure inside the buffer oxidizer to a certain level, and then closing the sixth valve; slowly opening the second valve for equaling a pressure inside the hydrocyclone to the pressure inside the buffer oxidizer;

(3) desalting at a first stage:

opening the first valve, starting the transporting motor of the hydrocyclone while backwardly starting the transporting motor of the buffer oxidizer, so as to spirally transport salts at the bottom of the hydrocyclone into the buffer oxidizer; at the same time, joining a high-temperature and high-pressure supercritical fluid which runs from the buffer oxidizer and through the filter and the second valve, with an overflow fluid of the hydrocyclone to form a joined fluid, and then entering subsequent pipes by the joined fluid; after a period of time, stopping the transporting motor of the hydrocyclone and the transporting motor of the buffer oxidizer, and closing the first valve and the second valve;

(4) desalting at a second stage:

opening the third valve and the fourth valve, forwardly starting the transporting motor of the buffer oxidizer to spirally transport the salts into the flash tank; vaporizing to generate steam and entering by the steam into the storage tank; entering, by the salts after being dried, via the fifth valve into the salt storage; and

(5) discharging salt intermittently:

stopping the transporting motor of the buffer oxidizer, and closing the third valve; repeating the step (2); when the pressure inside the flash tank reaches a normal pressure, opening the fifth valve, discharging the salts after being dried, and then burying the discharged salts; after a period of time, closing the fifth valve, and opening the first valve, so as to discharging the salts for one-time.

Preferably, the method further comprises a step of: connecting a globe valve between the sixth valve and the buffer oxidizer.

According to the present invention, the method for controlling desalination and salt discharging in the SCWO system is capable of accomplish the efficient and continuous desalination of the organic waste SCWO treatment system, via storing the salts by the salt storage buffer tank under the hydrocyclone and the buffer oxidizer.

### BRIEF DESCRIPTION OF THE DRAWINGS

The present invention is further illustrated combined with the following drawings and the preferred embodiments.

FIG. 1 is a sketch view of a method for controlling desalination and salt discharging in a SCWO system according to a preferred embodiment of the present invention.

1-heating furnace; 2-hydrocyclone; 3-buffer oxidizer; 4-flash tank; 5-salt storage; 6-storage tank; 7-filter; 8-spirial transporting motor of hydrocyclone; 9-spiral transporting motor of buffer oxidizer; 10-first control valve V1 of outlet of hydrocyclone; 11-second control valve V2 of outlet of filter; 12-third control valve V3 of outlet of buffer oxidizer; 13-fourth control valve V4 of outlet at top of buffer oxidizer; 14-fifth control valve V5 of outlet at bottom of buffer oxidizer; 15-sixth control valve V6 of oxygen feeding pipe; 16-globe valve V7 of oxygen feeding pipe; PIC01-first pressure meter in buffer oxidizer; PI02-second pressure meter in flash tank.

### DETAILED DESCRIPTION OF THE PREFERRED EMBODIMENT

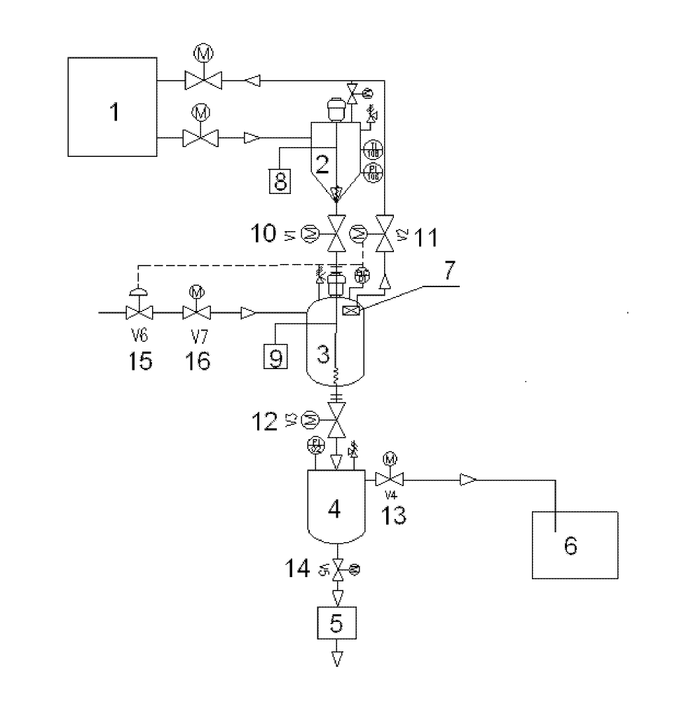

Referring to FIG. 1 of the drawings, according to a preferred embodiment of the present invention, in a desalination system of an organic waste SCWO treatment, an introducing pipe of a heating furnace 1 is connected to an inlet of a hydrocyclone 2; an overflow mouth at a top of the hydrocyclone 2 is connected to a pipe which leads back to the heating furnace 1; a salt storage buffer tank which is connected to a built-in transporting motor 8 thereof is provided at a bottom of the hydrocyclone 2; an outlet at the bottom of the hydrocyclone 2 is connected to a first inlet at a top of a buffer oxidizer 3; the buffer oxidizer 3 is connected to a spiral transporting motor 9 of the buffer oxidizer 3; a second inlet of the buffer oxidizer 3 is connected to an oxygen-feeding pipe; a filter 7 is provided in the buffer oxidizer 3; an outlet of the filter 7 is connected to the overflow mouth of the hydrocylone 2; an outlet at the bottom of the buffer oxidizer 3 is connected to a flash tank 4; a first outlet at a top of the flash tank 4 is connected to a storage tank 6; and a second outlet at a bottom of the flash tank 4 is connected to a salt storage 5.

Further, a first control valve V1 is connected between the outlet at the bottom of the hydrocyclone 2; a second control valve V2 is connected between the outlet of the filter 7 and the heating furnace 1; a third control valve V3 is connected between the outlet of the buffer oxidizer 3 and the inlet of the flash tank 4; a fourth control valve V4 is connected between the first outlet at the top of the flash tank 4 and the storage tank 6; a fifth control valve V5 is connected between the second outlet at the bottom of the flash tank 4 and the salt storage 5; a first pressure meter PIC01 is provided in the buffer oxidizer 3; and a second pressure meter PI02 is provided in the flash tank 4.

A method for control desalination of the desalination system comprises steps of: discharging salts from the hydrocyclone 2 into the buffer oxidizer 3; and discharging the salts from the buffer oxidizer 3 into the flash tank 4.

The method comprises steps of:

at an initial state, closing the valves V1, V2, V3, V6, V7 and V5; stopping the transporting motors 8 and 9 of the hydrocyclone 2 and the buffer oxidizer 3;

operating a first desalination, comprising steps of:

(1) starting the system, changing to feed in organic wastewater from feeding in clean water, opening the seventh valve V7 on the oxygen-feeding pipe, slowly opening the sixth valve V6 to a certain degree for introducing oxygen into the buffer oxidizer 3 and increasing a pressure inside the buffer oxidizer 3 to 4-5 MPa, and then closing the sixth valve V6 and the seventh valve V7;

(2) slowly opening the second valve V2 for equalizing a pressure inside the hydrocyclone 2 to the pressure inside the buffer oxidizer 3;

(3) when changing lasts for about 20 min, opening the first valve V1, starting the spiral transporting motor 8 of the hydrocyclone 2 while starting the spiral transporting motor 9 of the buffer oxidizer 3, so as to transport salts at the bottom of the hydrocyclone 2 into the buffer oxidizer 3, wherein the spiral transporting motor 9 rotates backwardly and transports counter-spirally; at the same time, joining a supercritical fluid at a working temperature of 400-500° C. and a pressure of 25-35 MPa which runs from the buffer oxidizer 3 and through the filter 7 and the second valve V2 with an overflow fluid of the hydrocyclone 2 to form a joined fluid, and entering subsequent pipes by the joined fluid; and

(4) stopping the spiral transporting motor 8 of the hydrocyclone 2 when 10 min after starting, and closing the first valve V1;

operating a second desalination, comprising steps of:

closing the spiral transporting motor 8 of the hydrocyclone 2, closing the first valve V1 and the second valve V2 at the top of the buffer oxidizer 3, opening the third valve V3 at the bottom of the buffer oxidizer V3, and starting the spiral motor 9 of the buffer oxidizer 3 to transport the salts into the flash tank 4, wherein the spiral motor 9 rotates forwardly and the fourth valve V4 is opened firstly; vaporizing to generate steam and entering by the steam into the storage tank 6; discharging, by the salt storage 5, the salts after being dried and the burying the discharged salts; and automatically controlling intermittent salt dischargings, comprising steps of:

(I) closing the first valve V1 and the second valve V2;

(II) slowly opening the third valve V3, shifting the spiral transporting motor 9 of the buffer oxidizer 3 to rotate forwardly to output the salts, slowly transporting the outputted salts into the flash tank 4;

(III) freely expanding, by a fluid containing the outputted salts, in the flash tank 4, so as to generate steam which enters the storage tank 6 and generate the salts after being dried which are stored at the bottom of the flash tank 4;

(IV) when discharging salt is over, wherein the pressure PI02 inside the flash tank 4 is equal to the pressure PIC01 inside the buffer oxidizer 3, stopping the spiral transporting motor 9 on the buffer oxidizer 3 and closing the third valve V3;

(V) opening the seventh valve V7, slowing opening the sixth valve V6 to a certain degree to introducing oxygen into the buffer oxidizer 3 and increasing the pressure PIC01 inside the buffer oxidizer 3 to a certain level, and then closing the sixth valve V6 and the seventh valve V7;

(VI) slowing opening the second valve V2 for equalizing the pressure inside the hydrocyclone 2 to the pressure inside the buffer oxidizer 3;

(VII) when the pressure PI02 inside the flash tank 4 reaches a normal pressure, opening the fifth valve V5 of the second outlet at the bottom of the flash tank 4, and discharging the salts after being dried, burying the discharged salts; after a period of time, closing the fifth valve V5; and

(VIII) after the fifth valve V5 is closed, opening the first valve V1, so to discharge the salts for one-time.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for controlling desalination and salt discharging in a supercritical water oxidation system, comprising steps of:
providing a supercritical water oxidation system, comprising steps of: connecting an introducing pipe of a heating furnace to an inlet of a hydrocyclone; connecting an overflow mouth at a top of the hydrocyclone to a pipe which leads back to the heating furnace; providing a salt storage buffer tank which is connected to a built-in transporting motor thereof at a bottom of the hydrocyclone; connecting an outlet of the salt storage buffer tank to a buffer oxidizer which has a built-in transporting motor thereof via a first valve; connecting an inlet of the buffer oxidizer to an oxygen-feeding pipe via a sixth valve; providing a filter in the buffer oxidizer; connecting an outlet of the filter to the overflow mouth of the hydrocyclone via a second valve; connecting an outlet at a bottom of the buffer oxidizer to a flash tank via a third valve; connecting a first outlet at a top of the flash tank to a storage tank via a fourth valve; and connecting a second outlet at a bottom of the flash tank to a salt storage via a fifth valve; and
controlling desalination and salt discharging, comprising steps of:
(1) initially, closing the first, the second, the third, the fourth, the fifth and the sixth valves, and stopping the transporting motor of the hydrocylcone and the transporting motor of the buffer oxidizer;
(2) starting the supercritical water oxidation system, entering the inlet of the hydrocyclone by organic wastewater, slowly opening the sixth valve to a certain degree for introducing oxygen into the buffer oxidizer and increasing a pressure inside the buffer oxidizer to a certain level, and then closing the sixth valve; slowly opening the second valve for equaling a pressure inside the hydrocyclone to the pressure inside the buffer oxidizer;
(3) desalting at a first stage, comprising steps of:
opening the first valve, starting the transporting motor of the hydrocyclone while backwardly starting the transporting motor of the buffer oxidizer, so as to spirally transport salts at the bottom of the hydrocyclone into the buffer oxidizer; at the same time, joining a high-temperature and high-pressure supercritical fluid which runs from the buffer oxidizer and through the filter and the second valve with an overflow fluid of the hydrocyclone to form a joined fluid, and then entering subsequent pipes by the joined fluid; after a period of time, stopping the transporting motor of the hydrocyclone and the transporting motor of the buffer oxidizer, and closing the first valve and the second valve;
(4) desalting at a second stage, comprising steps of:
opening the third valve and the fourth valve, forwardly starting the transporting motor of the buffer oxidizer to spirally transport the salts into the flash tank; vaporizing to generate steam and entering by the steam into the storage tank; entering, by the salts after being dried, via the fifth valve into the salt storage; and
(5) discharging salt intermittently, comprising steps of:
stopping the transporting motor of the buffer oxidizer, and closing the third valve; repeating the step (2); when the pressure inside the flash tank reaches a normal pressure, opening the fifth valve, discharging the salts after being dried, and then burying the discharged salts; after a period of time, closing the fifth valve, and opening the first valve, so as to discharging the salts for one-time.

2. The method, as recited in claim 1, wherein a globe valve is connected between the sixth valve and the buffer oxidizer.
